(19) United States
(12) Patent Application Publication
(10) Pub. No.: US 2019/0082758 A1
(43) Pub. Date: Mar. 21, 2019

(54) FABRIC

(71) Applicant: Mackent Fabrics Co., Ltd., Taoyuan City (TW)

(72) Inventors: Yi-Chen LIN, Taoyuan City (TW); Po-Jen SHIH, Taoyuan City (TW)

(21) Appl. No.: 16/132,939

(22) Filed: Sep. 17, 2018

Related U.S. Application Data
(60) Provisional application No. 62/559,796, filed on Sep. 18, 2017.
(60) Provisional application No. 62/581,997, filed on Nov. 6, 2017.

(30) Foreign Application Priority Data
Jun. 6, 2018 (TW) 107119556

(51) Int. Cl. A41D 31/02; B32B 27/02; B32B 5/02; B32B 5/14; B32B 27/06; B32B 27/12; B32B 33/00; B32B 5/30

(52) U.S. Cl. CPC A41D 31/02; B32B 27/02; B32B 5/026; B32B 5/145; B32B 27/06; B32B 27/12; B32B 2305/186; B32B 5/30; B32B 2437/00; B32B 2307/308; B32B 2307/404; B32B 2307/4026; B32B 2307/414; B32B 33/00

(57) ABSTRACT

A fabric includes a first textile layer, a second textile layer, and a middle textile layer. The first textile layer includes a plurality of first fiber yarns. The second textile layer is separated from the first textile layer, and the second textile layer includes a plurality of second fiber yarns. The middle textile layer is between the first textile layer and the second textile layer, and the middle textile layer includes a plurality of middle fiber yarns. One or more of the middle fiber yarns has one or more peak and one or more valley. The peak is knitted with the first textile layer and the valley is knitted with the second textile layer. Sizes of the fiber yarns are 30 deniers, weaving densities of the fiber yarns are less than 28 and the opacity rate of the fabric is less than 15%.

### CROSS-REFERENCES TO RELATED APPLICATIONS

This application claims the priority benefit of U.S. provisional application Ser. No. 62/559,796, filed on Sep. 18, 2017, Ser. No. 62/581,997, filed on Nov. 6, 2017, and Patent Application No. 107119556 filed in Taiwan, R.O.C. on Jun. 6, 2018. The entirety of the above-mentioned patent applications are hereby incorporated by references herein and made a part of the specification.

### BACKGROUND

### Technical Field

The instant disclosure relates to a fabric structure, in particular, to a fabric with a higher light transmittance.

### Related Art

In general, fabrics are provided for the purpose of basic warm-keeping function. However, modern customers have much higher demands on fabrics and pursue fabrics with different colors and patterns to present various, beautiful, and fashion effects.

In the art known to the inventor(s), in order to allow the fabric to have pattern and color, in general, different dyes are directly printed on the outer surface of the fabric or added to the fibers for manufacturing the fabric. However, as a result, the pattern or the color is only provided on the outer surface of the fabric. Furthermore, the pattern or the color would block a sufficient amount of the visible light so as to reduce the light transmittance of the fabric.

### SUMMARY

One embodiment of the instant disclosure provides a fabric comprising a first textile layer, a second textile layer, and a middle textile layer. The middle textile layer is between the first textile layer and the second textile layer and comprises a plurality of middle fiber yarns extending along a second direction. At least one of the middle fiber yarns has at least one peak and at least one valley. The at least one peak is knitted with the first textile layer and the at least one valley is knitted with the second textile layer.

Sizes of the first fiber yarns, the second fiber yarns, and the middle fiber yarns are 30 deniers, weaving densities of the first fiber yarns, the second fiber yarns, and the middle fiber yarns are less than 28 and the opacity rate of the fabric is less than 15%.

Accordingly, in the fabric according to one or some embodiments of the instant disclosure, the at least one peak of the at least one of the middle fiber yarns of the middle textile layer is knitted with the first textile layer, and the at least one valley of the at least one of the middle fiber yarns of the middle textile layer is knitted with the second textile layer. Furthermore, The sizes of the first fiber yarns, the second fiber yarns, and the middle fiber yarns are 30 deniers, and the weaving densities of the first fiber yarns, the second fiber yarns, and the middle fiber yarns are less than 28 G (number of stitches), so that the opacity rate of the fabric is less than 15%. Therefore, the fabric is light permissible.

### BRIEF DESCRIPTION OF THE DRAWINGS

The disclosure will become more fully understood from the detailed description given herein below for illustration only, and thus not limited to the disclosure, wherein:

FIG. 1 illustrates a lateral view of a fabric according to one embodiment of the instant disclosure;

FIG. 2 illustrates a lateral view of a fabric according to another embodiment of the instant disclosure;

FIG. 3(a) illustrates a top view of a first textile layer of the fabric of the another embodiment;

FIG. 3(b) illustrates a top view of a second textile layer of the fabric of the another embodiment;

FIG. 3(c) illustrates a top view of a fabric formed by stacking the first textile layer of FIG. 3(a) and the second textile layer of FIG. 3(b);

FIG. 4 illustrates a lateral view of a fabric according to a further embodiment of the instant disclosure;

FIG. 5 illustrates a lateral view of a fabric according to further another embodiment of the instant disclosure;

FIG. 6(a) illustrates a top view of a first textile layer of a fabric according to yet another embodiment of the instant disclosure;

FIG. 6(b) illustrates a top view of a second textile layer of the fabric of the yet another embodiment;

FIG. 6(c) illustrates a top view of the fabric of the yet another embodiment;

FIG. 7(a) illustrates a top view of a first textile layer of a fabric according to still another embodiment of the instant disclosure;

FIG. 7(b) illustrates a top view of a second textile layer of the fabric of the still another embodiment;

FIG. 7(c) illustrates a perspective view of a fabric formed by stacking the first textile layer of FIG. 7(a) and the second textile layer of FIG. 7(b);

FIG. 7(d) illustrates another perspective view of the fabric formed by stacking the first textile layer of FIG. 7(a) and the second textile layer of FIG. 7(b);

FIG. 8 illustrates a lateral view of a fabric according to still further embodiment of the instant disclosure;

FIG. 9 illustrates a lateral view of a fabric according to still further another embodiment of the instant disclosure;

FIG. 10 illustrates a lateral view of a fabric according to still yet another embodiment of the instant disclosure; and

FIG. 11 illustrates a lateral view of a fabric according to still further yet another embodiment of the instant disclosure.

### DETAILED DESCRIPTION

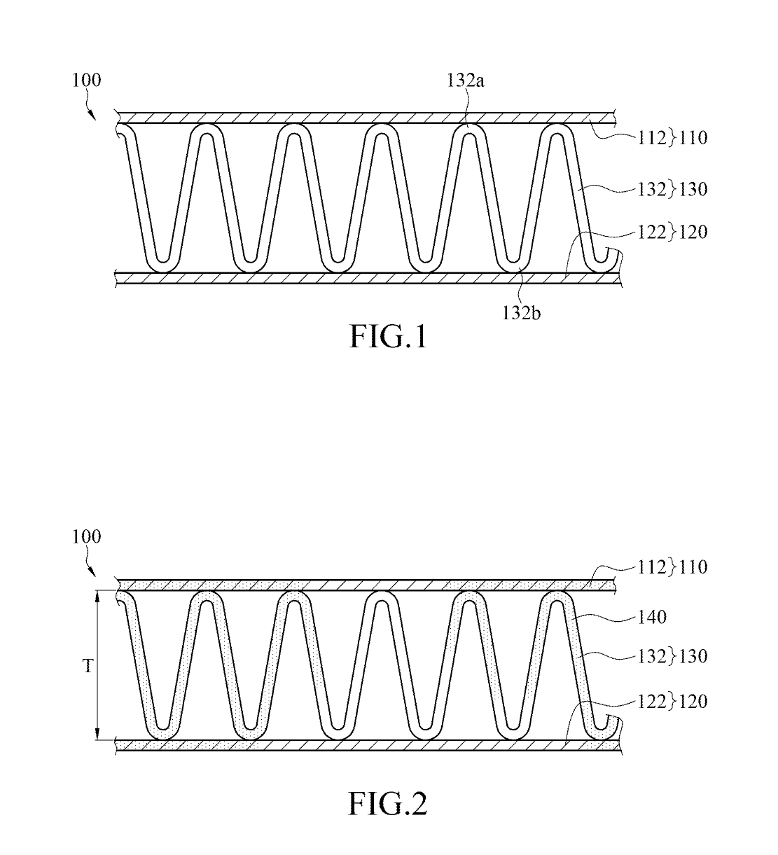

FIG. 1 illustrates a lateral view of a fabric according to one embodiment of the instant disclosure. Please refer to FIG. 1. The fabric 100 comprises a first textile layer 110, a second textile layer 120, and a middle textile layer 130. The first textile layer 110 comprises a plurality of first fiber yarns 112. The second textile layer 120 is separated from the first textile layer 110, and the second textile layer 120 comprises a plurality of second fiber yarns 122. The middle textile layer 130 is between the first textile layer 110 and the second textile layer 120, and the middle textile layer 130 comprises a plurality of middle fiber yarns 132. At least one of the middle fiber yarns 132 has at least one peak 132a and at least one valley 132b. The at least one peak 132a is knitted with the first textile layer 110, and the at least one valley 132b is knitted with the second textile layer 120. The sizes of the first fiber yarns 112, the second fiber yarns 122, and the middle fiber yarns 132 are 30 deniers, the weaving densities of the first fiber yarns 112, the second fiber yarns 122, and the middle fiber yarns 132 are less than 28 G (number of stitches), and the opacity rate of the fabric 100 is less than 15%.

In one embodiment, the upper knitting needle and the lower knitting needle of the middle fiber yarns 132 of the middle textile layer 130 may be interlaced with each other, so that the yarn rings of the first fiber yarns 112 and the second fiber yarns 122 are staggered with each other, so that the entire fabric 100 is allowed to be light permissible.

In one embodiment, as shown in FIG. 2, the fabric 100 further comprises a plurality of dyes 140 adhered on the first fiber yarns 112, and/ or the second fiber yarns 122, and/or the third fiber yarns 132. In other words, each of the dyes 140 is adhered on at least one selected from a group consisting of the first fiber yarns and the second fiber yarns and moves toward the middle fiber yarns by a depth, and the depths the dyes moved are different from each other. Namely, the dyes 140 are adhered on at least one of the fiber yarns (the first fiber yarns 112, the second fiber yarns 122, and the third fiber yarns 132). Here, the dyes 140 may form a first color on the color area M1 of the first textile layer 110 and/or may form a second color on the color area M2 of the second textile layer 120.

In one embodiment, as shown in FIG. 2, the middle textile layer 130 has a thickness T. When the dyes 140 are applied on the first textile layer 110, the dyes 140 are moved from the first fiber yarns 112 toward the middle fiber yarns 132 by a depth (a distance) and adhered on the middle fiber yarns 132. The depths the dyes 140 moved are different from each other. In another embodiment, the dyes 140 are moved from the first fiber yarns 112 toward the middle fiber yarns 132 and adhered on the second fiber yarns 122. Here, the depths the dyes 140 moved are less than or equal to the thickness T of the middle textile layer 130. In one embodiment, the thickness T of the middle textile layer 130 is at least 1.5 mm.

In one embodiment, the dyes 140 may have different colors. In another embodiment, the dyes 140 may have the same color but different concentrations. Here, when lights incident into the fabric 100 from the first textile layer 110 toward the second textile layer 120 and the direction of the viewing angle is from the first textile layer 110 toward the second textile layer 120, the first textile layer 110 may present a gradation effect of the same color system or different color systems.

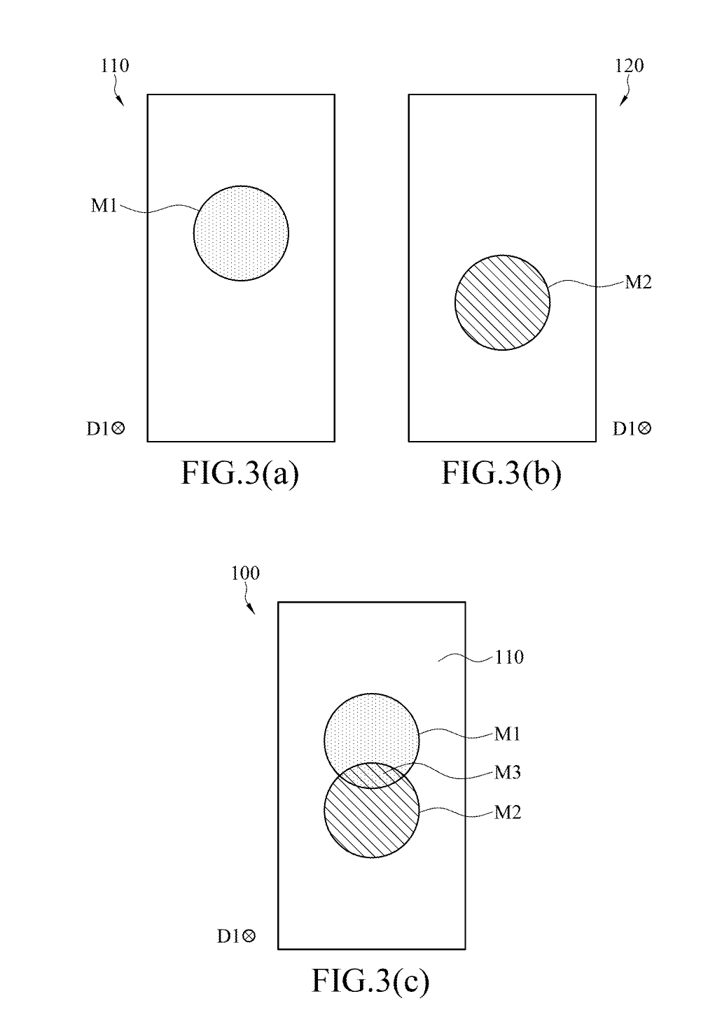

In one embodiment, as shown in FIG. 3(a), from a top view (in a direction DO, the first textile layer 110 has a color area M1. The color area M1 of the first textile layer 110 has a first color. As shown in FIG. 3(b), from a top view (in the direction D1), the second textile layer 120 has a color area M2, and the color area M2 of the second textile layer 120 has a second color. As shown in FIG. 3(c), when the first textile layer 110 is stacked on the second textile layer 120 and the lights incident into the fabric 100 from the first textile layer 110 toward the second textile layer 120 as well as the direction D1 of the viewing angle is from the first textile layer 110 toward the second textile layer 120, the second color is visible on the first textile layer 110 of the fabric 100, so that the first textile layer 110 presents the first color and the second color. In other words, when the viewing angle is from the first textile layer 110 toward the second textile layer 120, the second color of the second textile layer 120 below the first textile layer 110 can be seen through the first textile layer 110, so that the first textile layer 110 can present the first color and the second color.

In one embodiment, the first color and the second color may be different colors. Here, when lights incident into the fabric 100 from the first textile layer 110 toward the second textile layer 120 and the direction of the viewing angle is from the first textile layer 110 toward the second textile layer 120, a color area M3 by stacking the color area M1 with the color area M2 can present a third color formed by combining the first color with the second color, and the third color is visible on the first textile layer 110 of the fabric 100, as shown in FIG. 3(c). For example, when the first color is blue and the second color is red, and the direction of the viewing angle is from the first textile layer 110 toward the second textile layer 120, the overlapped portion between the color area M1 and the color area M2 present a purple color (the third color) formed by combining the blue color (the first color) with the red color (the second color).

In another embodiment, the first color and the second color may be the same color. Here, when lights incident into the fabric 100 from the first textile layer 110 toward the second textile layer 120 and the direction of the viewing angle is from the first textile layer 110 toward the second textile layer 120, the overlapped portion between the color area M1 of the first textile layer 110 and the color area M2 can present a color in the same color system but different chromaticities with respect to the first color or the second color. For example, when both the first color and the second color are blue, and the direction of the viewing angle is from the first textile layer 110 toward the second textile layer 120, the color area formed by overlapping the color area M1 and the color area M2 presents a deeper blue color (the overlapping of the first color and the second color), and the non-overlapping portion between the color area M1 and the color area M2 presents a not-deepened blue color (the first color and the second color are not overlapped).

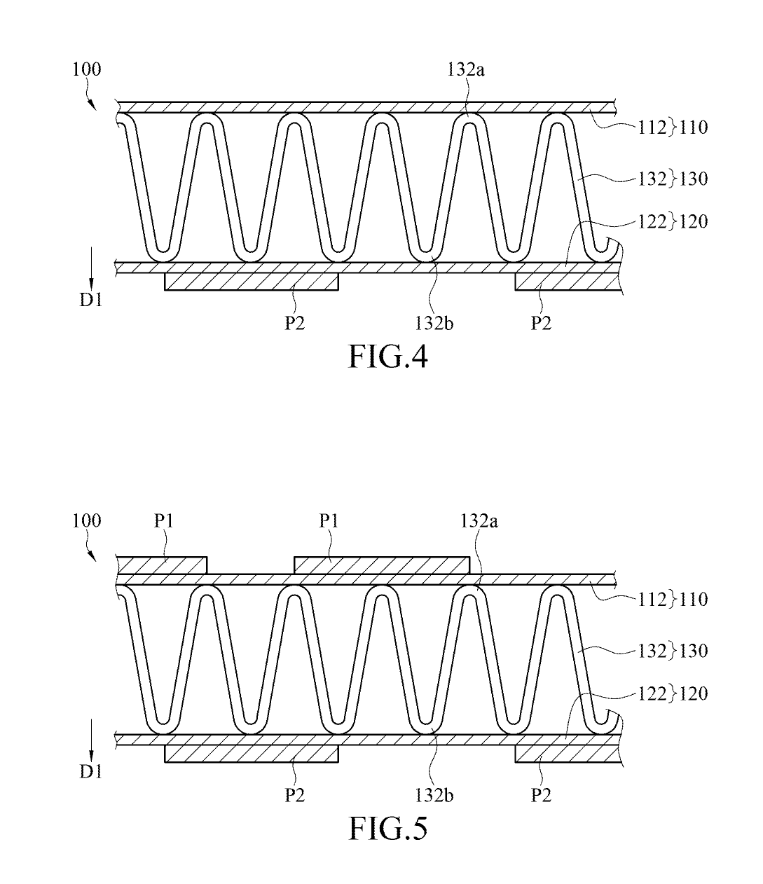

In one embodiment, as shown in FIG. 4, the first textile layer 110 may be void of any patterns, the second textile layer 120 may have a lower layer pattern P2, and the lower layer pattern P2 is visible on the first textile layer 110 of the fabric 100. When lights incident into the fabric 100 from the first textile layer 110 toward the second textile layer 120 and the direction D1 of the viewing angle is from the first textile layer 110 toward the second textile layer 120, the lower layer pattern P2 is visible on the first textile layer 110 of the fabric 100, so that the first textile layer 110 presents the lower layer pattern P2. In other words, when the direction of the viewing angle is from the first textile layer 110 toward the second textile layer 120, the lower layer pattern P2 of the second textile layer 120 below the first textile layer 110 can be seen through the first textile layer 110, so that the first textile layer 110 can present the lower layer pattern P2.

In one embodiment, as shown in FIG. 5, the first textile layer 110 may have an upper layer pattern P1 and the second textile layer 120 may have a lower layer pattern P2. When lights incident into the fabric 100 from the first textile layer 110 toward the second textile layer 120 and the direction D1 of the viewing angle is from the first textile layer 110 toward the second textile layer 120, the lower layer pattern P2 is visible on the first textile layer 110 of the fabric 100, so that the first textile layer 110 presents the upper layer pattern P1 and the lower layer pattern P2. In other words, when the direction of the viewing angle is from the first textile layer 110 toward the second textile layer 120, the lower layer pattern P2 of the second textile layer 120 below the first textile layer 110 can be seen through the first textile layer 110, so that the first textile layer 110 can present the lower layer pattern P2 and the upper layer pattern P1.

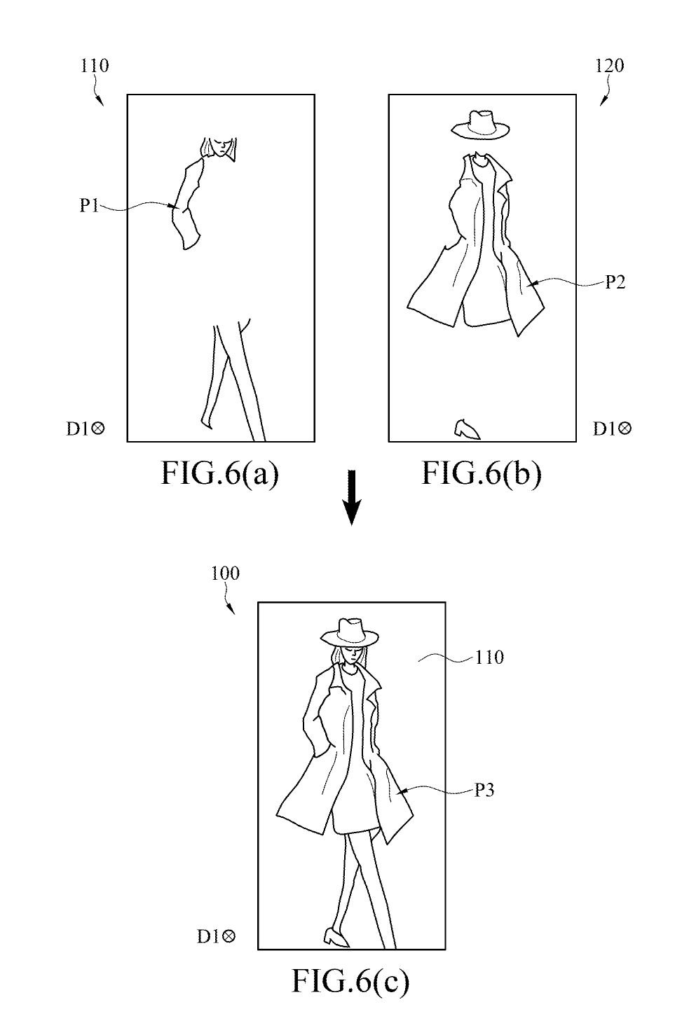

In one embodiment, the upper layer pattern P1 of the first textile layer 110 (as shown in FIG. 6(a)) and the lower layer pattern P2 of the second textile layer 120 (as shown in FIG. 6(b)) may be different parts of an entire pattern. Here, as shown in FIG. 6(c), when the first textile layer 110 is stacked on the second textile layer 120 and the lights incident into the fabric 100 from the first textile layer 110 toward the second textile layer 120 as well as the direction D1 of the viewing angle is from the first textile layer 110 toward the second textile layer 120, the upper layer pattern P1 and the lower layer pattern P2 are stacked with each other to form an entire pattern P3, and the entire pattern P3 is visible on the first textile layer 110 of the fabric 100.

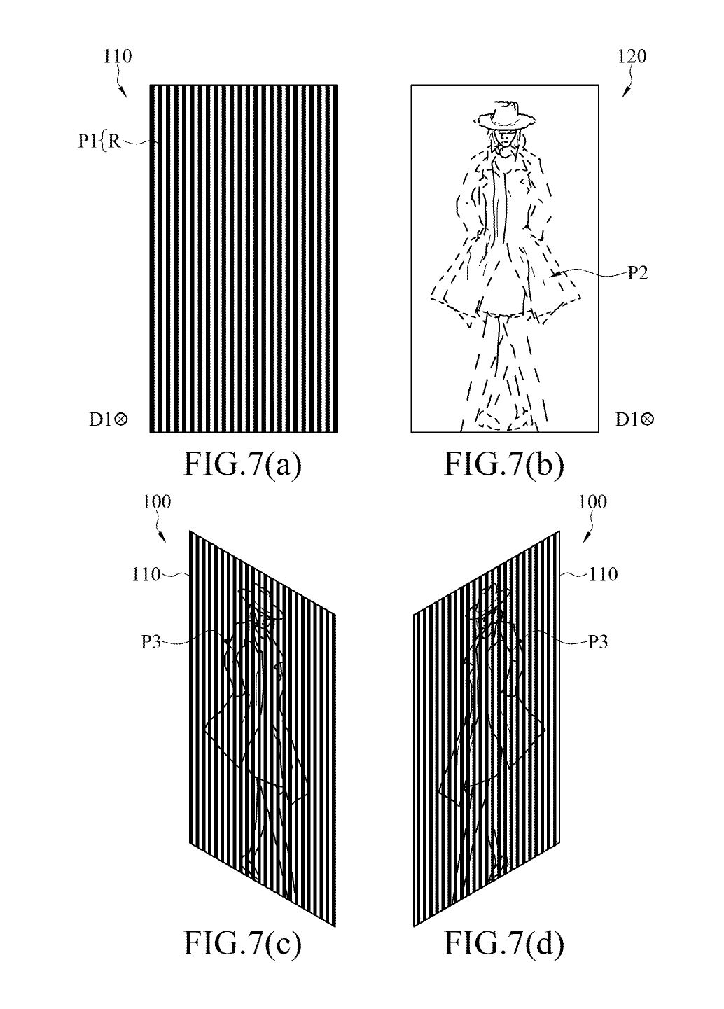

In another embodiment, the upper layer pattern P1 of the first textile layer 110 comprises a plurality of fence-like textures R separated from each other, as shown in FIG. 7(a). The second textile layer 120 has a lower layer pattern P2, and the lower layer pattern P2 is a composite pattern formed by two different patterns, as shown in FIG. 7(b). For example, the lower layer pattern P2 may be a composite pattern formed by a picture having a girl facing rightward and a picture having a girl facing leftward. Here, when the first textile layer 110 is stacked on the second textile layer 120 and the lights incident into the fabric 100 from the first textile layer 110 toward the second textile layer 120 as well as the direction D1 of the viewing angle is from the first textile layer 110 toward the second textile layer 120, parts of the lower layer pattern P2 of the second textile layer 120 is visible through gaps between the fence-like textures R, and the entire pattern P3 is changed in accordance with the change of the light incident direction, e.g., the entire pattern is presented in a dynamic manner. For example, when viewing the entire pattern P3 from one viewing angle, as shown in FIG. 7(c), an image having a girl facing rightward is presented; while when viewing the entire pattern P3 from another viewing angle, as shown in FIG. 7(d), an image having a girl facing leftward is presented. The effect is similar to the three-dimensional performance presented by the hologram techniques.

In one embodiment, the fabric 100 further comprises a third textile layer 150, and the third textile layer 150 is laminated with the second textile layer 120.

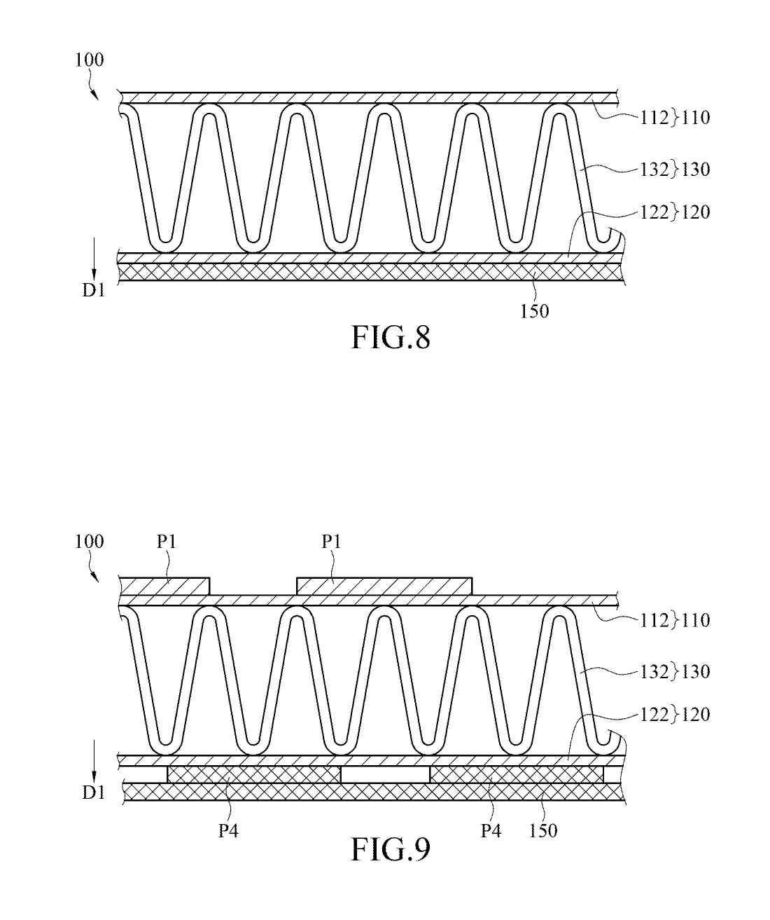

In one embodiment, as shown in FIG. 8, the third textile layer 150 is a cotton layer and is opaque. The first textile layer 110, the second textile layer 120, and the third textile layer 150 may be devoid of any patterns. Because of the light-permissible property of the first textile layer 110, the second textile layer 120, and the middle textile layer 150, when the lights incident into the fabric 100 from the first textile layer 110 toward the third textile layer 150 and the direction D1 of the viewing angle is from the first textile layer 110 toward the third textile layer 150, the color of the third textile layer 150 is visible on the first textile layer 110 of the fabric 100. In another embodiment, the third textile layer 150 is a skin-friendly cloth.

In a further embodiment, as shown in FIG. 9, the first textile layer 110 has an upper layer pattern P1, the second textile layer 120 is devoid of any patterns, and the third textile layer 150 has an inner layer pattern P4. When the lights incident into the fabric 100 from the first textile layer 110 toward the third textile layer 150 and the direction D1 of the viewing angle is from the first textile layer 110 toward the third textile layer 150, the inner layer pattern P4 is visible on the first textile layer 110 of the fabric 100, so that the first textile layer 110 presents the upper layer pattern P1 and the inner layer pattern P4. Here, when the lights incident into the fabric 100 from the first textile layer 110 toward the third textile layer 150 and the direction of the viewing angle is from the first textile layer 110 toward the third textile layer 150, the upper layer pattern P1 and the inner layer pattern P4 may be stacked with each other to form an entire pattern (not shown), and the entire pattern is visible on the first textile layer 110 of the fabric 100.

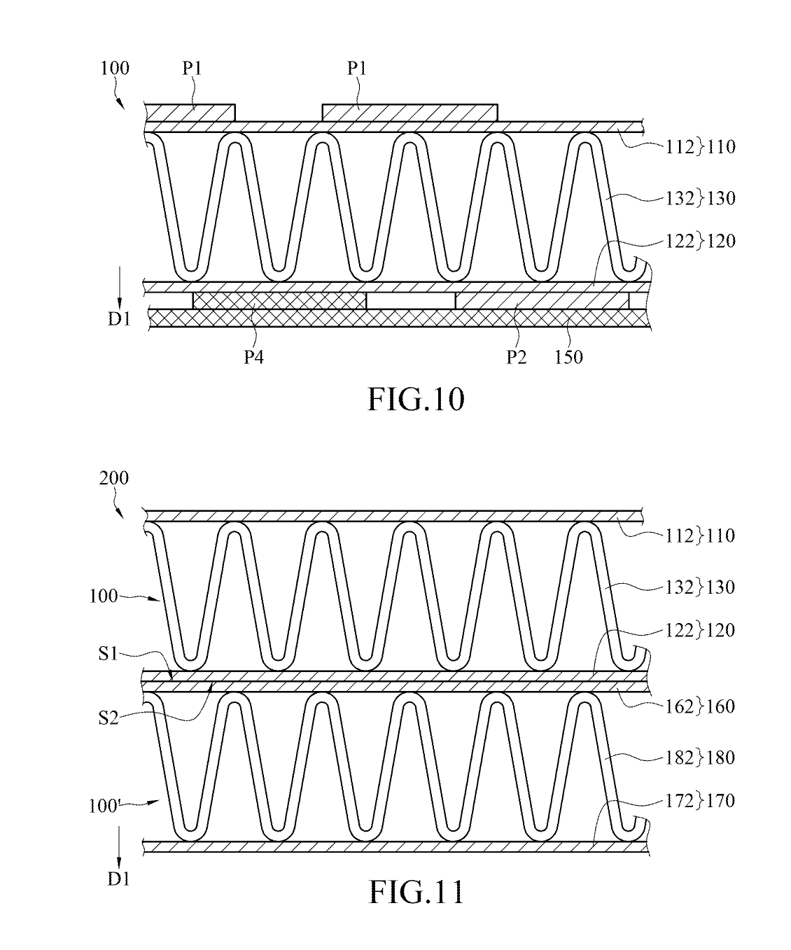

In yet another embodiment, as shown in FIG. 10, the first textile layer 110 has an upper layer pattern P1, the second textile layer 120 has a lower layer pattern P2, and the third textile layer 150 has an inner layer pattern P4. When the lights incident into the fabric 100 from the first textile layer 110 toward the third textile layer 150 and the direction D1 of the viewing angle is from the first textile layer 110 toward the third textile layer 150, the inner layer pattern P4 and the lower layer pattern P2 are visible on the first textile layer 110 of the fabric 100, so that the first textile layer 110 presents the upper layer pattern P1, the lower layer pattern P2, and the inner layer pattern P4. Here, when the lights incident into the fabric 100 from the first textile layer 110 toward the third textile layer 150 and the direction of the viewing angle is from the first textile layer 110 toward the third textile layer 150, the upper layer pattern P1, the lower layer pattern P2, and the inner layer pattern P4 may be stacked with each other to form an entire pattern (not shown), and the entire pattern is visible on the first textile layer 110 of the fabric 100.

Here, a portion of or all the pattern of at least one of the layers (the first textile layer 110, the second textile layer 120, and the third textile layer 150) may be different from the pattern of other textile layer(s). For example, a portion of or all the upper layer pattern P1 of the first textile layer 110 can be different from a portion of or all the lower layer pattern P2 of the second textile layer 120 and different from a portion of or all the inner layer pattern P4 of the third textile layer 150. Alternatively, a portion of or all the lower layer pattern P2 of the second textile layer 120 is different from a portion of or all the upper layer pattern P1 of the first textile layer 110 and different from a portion of or all the inner layer pattern P4 of the third textile layer 150. Alternatively, a portion of or all the pattern of each of the layers is different from the other layers. In another embodiment, a portion of or all the pattern of each of the layers may be the same.

In another embodiment, as shown in FIG. 11, a fabric 200 comprises, besides the fabric 100, another fabric 100′. That is, the fabric 200 comprises the fabric 100, another first textile layer 160, another second textile layer 170, and another middle textile layer 180. A surface Si of the another first textile layer 160 is on a surface S2 at one side of the second textile layer 120 opposite to the middle textile layer 130 and combined with the second textile layer 120. The another second textile layer 170 is on the another first textile layer 160, and the another middle textile layer 180 is between the another first textile layer 160 and the another second textile layer 170.

In some embodiments, the another first textile layer 160 comprises a plurality of another first fiber yarns 162, and a size of each of the another first fiber yarns 162 is different from a size of each of the first fiber yarns 112. The another second textile layer 170 comprises a plurality of another second fiber yarns 172, and a size of each of the another second fiber yarns 172 is different from a size of each of the second fiber yarns 122. The another middle textile layer 180 comprises a plurality of another middle fiber yarns 182, and a size of each of the another middle fiber yarns 182 is different from a size of each of the middle fiber yarns 132. That is, the sizes of the another first fiber yarns 162, the another second fiber yarns 172, and the another middle fiber yarns 182 of the another fabric 100′ are different from the sizes of the first fiber yarns 112, the second fiber yarns 122, and the middle fiber yarns 132 of the fabric 100.

In some other embodiments, weaving densities of the another first fiber yarns 162 of the another first textile layer 160, the another second fiber yarns 172 of the another second textile layer 170, and the another middle fiber yarns 182 of the another middle textile layer 180 are different from weaving densities of the first fiber yarns 112 of the first textile layer 110, the second fiber yarns 122 of the second textile layer 120, and the middle fiber yarns 132 of the middle textile layer 130. That is, weaving densities of the another first fiber yarns 162, the another second fiber yarns 172, and the another middle fiber yarns 182 of the another fabric 100′ are different from weaving densities of the first fiber yarns 112, the second fiber yarns 122, and the middle fiber yarns 132 of the fabric 100.

When the sizes and the weaving densities of the another first fiber yarns 162, the another second fiber yarns 172, and the another middle fiber yarns 182 of the another fabric 100′ are greater than the sizes and the weaving densities of the first fiber yarns 112, the second fiber yarns 122, and the middle fiber yarns 132, the opacity rate of the another fabric 100′ is greater than the opacity rate of the fabric 100. That is, when the lights incident into the fabric 200 from the first textile layer 110 of the fabric toward the another second textile layer 170 of the another fabric 100′ and the direction D1 of the viewing angle is from the first textile layer 110 of the fabric 100 toward the another second textile layer 170 of the another fabric 100′, the color of the another fabric 100′ is visible on the first textile layer 110 of the fabric 100.

In some embodiments, at least one of these pattern(s) (the upper layer pattern P1, the lower layer pattern P2, and the inner layer pattern P4) may be a printing pattern (as shown in FIGS. 6(a) to 6(c) and FIGS. 7(a) to 7(d)), a texture pattern, a jacquard pattern, a hologram pattern, alternative patterns, or any combinations of the foregoing. In some other embodiments, at least one of these pattern(s) may be different parts of an entire pattern. Accordingly, by the stacking of the layers, the fabric (the fabric 100 or the fabric 200) can present the entire pattern. In further some embodiments, at least one of these pattern(s) may be an entire pattern. Accordingly, by the stacking of the layers, the fabric (the fabric 100 or the fabric 200) can present the stacking or the arrangement among several same or different entire patterns.

Accordingly, in the fabric according to one or some embodiments of the instant disclosure, the at least one peak of the at least one of the middle fiber yarns of the middle textile layer is knitted with the first textile layer, and the at least one valley of the at least one of the middle fiber yarns of the middle textile layer is knitted with the second textile layer. Furthermore, The sizes of the first fiber yarns, the second fiber yarns, and the middle fiber yarns are 30 deniers, and the weaving densities of the first fiber yarns, the second fiber yarns, and the middle fiber yarns are less than 28 G (number of stitches), so that the opacity rate of the fabric is less than 15%. Therefore, the fabric is light permissible.

What is claimed is:

1. A fabric, comprising:
a first textile layer comprising a plurality of first fiber yarns;
a second textile layer separated from the first textile layer and comprising a plurality of second fiber yarns; and
a middle textile layer between the first textile layer and second textile layer, wherein the middle textile layer comprises a plurality of middle fiber yarns, at least one of the middle fiber yarns has at least one peak and at least one valley, the at least one peak is knitted with the first textile layer, and the at least one valley is knitted with the second textile layer;
wherein, sizes of the first fiber yarns, the second fiber yarns, and the middle fiber yarns are 30 deniers, weaving densities of the first fiber yarns, the second fiber yarns, and the middle fiber yarns are less than 28 and the opacity rate of the fabric is less than 15%.

2. The fabric according to claim 1, wherein a thickness of the middle textile layer is at least 1.5 mm.

3. The fabric according to claim 1, further comprising a plurality of dyes, each of the dyes is adhered on at least one selected from a group consisting of the first fiber yarns and the second fiber yarns and moves toward the middle fiber yarns by a depth, and the depths the dyes moved are different from each other.

4. The fabric according to claim 3, wherein the dyes have a same color and different concentrations.

5. The fabric according to claim 3, wherein the dyes have different colors.

6. The fabric according to claim 1, wherein the first textile layer has a color area and the second textile layer has a color area, the color area of the first textile layer has a first color, the color area of the second textile layer has a second color, the second color is visible on the first textile layer, so that the first textile layer presents the first color and the second color.

7. The fabric according to claim 6, wherein the first color is different from the second color, an overlapped portion between the color area of the first textile layer and the color area of the second textile layer presents a third color by combining the first color with the second color, and the third color is visible on the first textile layer.

8. The fabric according to claim 1, wherein the second textile layer has a lower layer pattern, the lower layer pattern is visible on the first textile layer.

9. The fabric according to claim 8, wherein the first textile layer has an upper layer pattern, the upper layer pattern and the lower layer pattern are stacked with each other to form an entire pattern.

10. The fabric according to claim 9, wherein the upper layer pattern comprises a plurality of fence-like textures separated from each other, parts of the lower layer pattern is visible through gaps between the fence-like textures, and the entire pattern is changed in accordance with the change of a light incident direction.

11. The fabric according to claim 10, further comprising a third textile layer laminated with the second textile layer, wherein the third textile layer has an inner layer pattern, the inner layer pattern is visible on the first textile layer, and the inner layer pattern, the upper layer pattern, and the lower layer pattern are stacked with each other to form the entire pattern.

12. The fabric according to claim 9, further comprising a third textile layer laminated with the second textile layer, wherein the third textile layer has an inner layer pattern, the inner layer pattern is visible on the first textile layer, and the inner layer pattern, the upper layer pattern, and the lower layer pattern are stacked with each other to form the entire pattern.

13. The fabric according to claim 1, further comprising a third textile layer laminated with the second textile layer.

14. The fabric according to claim 1, further comprising a third textile layer laminated with the second textile layer, wherein the first textile layer has an upper layer pattern, the third textile layer has an inner layer pattern, the inner layer pattern is visible on the first textile layer, and the inner layer pattern and the upper layer pattern are stacked with each other to form an entire pattern.

15. The fabric according to claim 1, further comprising another first textile layer, another second textile layer, and another middle textile layer, wherein a surface of the another first textile layer is at one side of the second textile layer opposite to the middle textile layer and is combined with the second textile layer, the another second textile layer is on the another first textile layer, and the another middle textile layer is between the another first textile layer and the another second textile layer.

16. The fabric according to claim 15, wherein the another first textile layer comprises a plurality of another first fiber yarns, the another second textile layer comprises a plurality of another second fiber yarns, and the another middle textile layer comprises a plurality of another middle fiber yarns, a size of each of the another first fiber yarns is different from a size of each of the first fiber yarns, a size of each of the another second fiber yarns is different from a size of each of the second fiber yarns, and a size of each of the another middle fiber yarns is different from a size of each of the middle fiber yarns.

17. The fabric according to claim 16, wherein weaving densities of the another first fiber yarns of the another first textile layer, the another second fiber yarns of the another second textile layer, and the another middle fiber yarns of the another middle textile layer are different from the weaving densities of the first fiber yarns of the first textile layer, the second fiber yarns of the second textile layer, and the middle fiber yarns of the middle textile layer.
